(19) United States
(12) Patent Application Publication
(10) Pub. No.: US 2026/0205762 A1
(43) Pub. Date: Jul. 16, 2026

(54) SOUND FIELD EQUALIZATION ADJUSTMENT METHOD AND APPARATUS, DEVICE AND COMPUTER READABLE STORAGE MEDIUM

(71) Applicant: HUIZHOU VISION NEW TECHNOLOGY CO., LTD., Huizhou, Guangdong (CN)

(72) Inventors: Qingxing JIANG, Huizhou, Guangdong (CN); Feixiang LIU, Huizhou, Guangdong (CN); Weibiao GAO, Huizhou, Guangdong (CN)

(73) Assignee: HUIZHOU VISION NEW TECHNOLOGY CO., LTD., Huizhou, Guangdong (CN)

(21) Appl. No.: 18/867,017

(22) PCT Filed: Mar. 8, 2023
(86) PCT No.: PCT/CN2023/080214

§ 371 Date: Nov. 19, 2024

(30) Foreign Application Priority Data
May 19, 2022 (CN) 202210552770.1

(51) Int. Cl. H04S 7/00; H04R 5/02

(52) U.S. Cl. CPC H04S 7/307; H04R 5/02

(57) ABSTRACT

A sound field equalization adjustment method is applied to a three-speaker system. The three-speaker system includes a dual-speakers and a middle speaker located above the dual-speakers. The sound field equalization adjustment method includes preprocessing an acquired stereo audio signal to obtain a target dual-channel signal, wherein the target dual-channel signal comprises audio signals of different frequencies, and adjusting an equalizer of each of the dual-speakers and/or the middle speaker based on the frequency of the audio signal, so that after the target dual-channel signal is played through the dual-speakers and the middle speaker, a target virtual sound image is positioned in a direction of a real sound image.

This application claims priority to Chinese Patent Application No. 202210552770.1, filed on May 19, 2022 and entitled “SOUND FIELD EQUALIZATION ADJUSTMENT METHOD AND APPARATUS, DEVICE AND COMPUTER READABLE STORAGE MEDIUM”. The entire disclosures of the above application are incorporated herein by reference.

### TECHNICAL FIELD

The present application relates to the field of virtual surround sound technologies, and in particular to a sound field equalization adjustment method and apparatus, a device and a computer readable storage medium.

### BACKGROUND TECHNOLOGY

With the continuous advancement of science and technology, users'expectations for televisions in areas such as audiovisual entertainment and gaming are increasingly high. In addition to picture quality, sound is also a crucial factor impacting the entertainment experience. Consequently, there are now numerous innovative television sound solutions on the market, including home theater systems, high-fidelity (Hi-Fi) standards, and 5.1 virtual surround speaker setups.

The virtual surround sound algorithm is one approach to enhancing the user experience. Virtual surround sound systems are based on stereo sound, creating a multi-directional audio experience without adding additional channels or speakers. By processing the sound field signals through circuitry, listeners perceive sound coming from multiple directions, resulting in an immersive, simulated stereo sound field.

However, in traditional dual-speakers-to-ear systems, the absence of sound wave radiation from above leads to limitations. In certain spatial directions, such as the vertical direction, achieving a virtual position is highly subjective and unreliable. Without audio-visual synchronization or movement of the virtual sound source, listeners find it challenging to discern sound location.

Therefore, there is still room for improvement and development in existing technology.

### SUMMARY OF INVENTION

### Technical Problem

Embodiments of the present application provide a sound field equalization adjustment method and apparatus, a device and a computer readable storage medium to address the issue of suboptimal virtual effects in certain spatial directions within dual-speakers systems.

### Technical Solutions

The technical solution of this application is as follows:

In a first aspect, the present application provides a sound field equalization adjustment method, wherein the sound field equalization adjustment method is applied to a three-speaker system, the three-speaker system comprises a dual-speakers and a middle speaker located above the dual-speakers, the sound field equalization adjustment method comprises:
preprocessing an acquired stereo audio signal to obtain a target dual-channel signal, wherein the target dual-channel signal comprises audio signals of different frequencies; and
adjusting an equalizer of each of the dual-speakers and/or the middle speaker based on the frequency of the audio signal, so that after the target dual-channel signal is played through the dual-speakers and the middle speaker, a target virtual sound image is positioned in a direction of a real sound image.

Further, preprocessing the acquired stereo audio signal to obtain the target dual-channel signal comprises:
preprocessing the stereo audio signal according to a preset head-related transfer function to obtain the target dual-channel signal.

Further, the middle speaker is located on a perpendicular bisector of a line connecting the dual-speakers, and adjusting the equalizer of each of the dual-speakers and/or the middle speaker based on the frequency of the audio signal comprises:
if the frequency of the audio signal is low, increasing a gain frequency of the equalizer corresponding to the middle speaker and maintaining the equalizer of the dual-speakers at a preset equalization parameter, such that the target virtual sound image is located at a first target position, and the first target position is a position above a midpoint of a triangle formed by a connection of the dual-speakers and the middle speaker.

Further, the middle speaker is located on a perpendicular bisector of a line connecting the dual-speakers, and adjusting the equalizer of each of the dual-speakers and/or the middle speaker based on the frequency of the audio signal comprises:
if the frequency of the audio signal is a reference frequency, maintaining the equalizers of the dual-speakers and the middle speaker at preset equalization parameters, such that the target virtual sound image is located at a midpoint of a triangle formed by a connection of the dual-speakers and the middle speaker.

Further, adjusting the equalizer of each of the dual-speakers and/or the middle speaker based on the frequency of the audio signal comprises:
if the frequency of the audio signal is midrange, adjusting the equalizer of the middle speaker to a low-pass filter, while maintaining the equalizer of the dual-speakers at a preset equalization parameter, such that that the target virtual sound image is located at a midpoint of a line connecting the dual-speakers.

Further, adjusting the equalizer of each of the dual-speakers and/or the middle speaker based on the frequency of the audio signal comprises:
if the frequency of the audio signal is high, horizontally extending the target virtual sound image based on the equalizer corresponding to the dual-speakers and a preset head-related transfer function, such that the target virtual sound image is located on an extended line at both ends of a line connecting the dual-speakers.

Further, the target dual-channel signal carries a virtual sound image information, and after preprocessing the acquired stereo audio signal to obtain the target dual-channel signal, the method further comprises:
if the virtual sound image information comprises a height information, adjusting a gain of the equalizer corresponding to the middle speaker, wherein the gain is a gain of the audio signal in a mid-high frequency range, to enhance the target virtual sound image.

In a second aspect, the present application provides a sound field equalization adjustment device, wherein the sound field equalization adjustment device is applied to a three-speaker system, the three-speaker system comprises a dual-speakers and a middle speaker located above the dual-speakers, the sound field equalization adjustment device comprises:
a processor configured to preprocess the acquired stereo audio signal to obtain a target dual-channel signal, wherein the target dual-channel signal comprises audio signals of different frequencies; and
an adjuster configured to adjust an equalizer of the dual-speakers and/or the middle speaker based on the frequency of the audio signal, such that a target virtual sound image is positioned in a direction of a real sound image.

Further, the processor is configured to preprocess the stereo audio signal according to a preset head-related transfer function to obtain the target dual-channel signal.

Further, the middle speaker is located on a perpendicular bisector of a line connecting the dual-speakers; wherein the adjuster is configured to:
if a frequency of the audio signal is low, increase a gain frequency of the equalizer corresponding to the middle speaker and maintain the equalizer of the dual-speakers at a preset equalization parameter, such that the target virtual sound image is located at a first target position, and the first target position is a position above a midpoint of a triangle formed by a connection of the dual-speakers and the middle speaker.

Further, the middle speaker is located on a perpendicular bisector of a line connecting the dual-speakers, and the adjuster is configured to:
if a frequency of the audio signal is a reference frequency, maintain the equalizers of the dual-speakers and the middle speaker at preset equalization parameters, such that the target virtual sound image is located at a midpoint of a triangle formed by a connection of the dual-speakers and the middle speaker.

Further, the adjuster is configured to:
if a frequency of the audio signal is midrange, adjust the equalizer of the middle speaker to a low-pass filter, while maintaining the equalizer of the dual-speakers at a preset equalization parameter, such that the target virtual sound image is located at a midpoint of a line connecting the dual-speakers.

Further, the adjuster is configured to:
if a frequency of the audio signal is high, horizontally extending the target virtual sound image based on the equalizer corresponding to the dual-speakers and a preset head-related transfer function, such that the target virtual sound image is located on an extended line at both ends of a line connecting the dual-speakers.

Further, the target dual-channel signal carries a virtual sound image information, and the processor preprocesses the acquired stereo audio signal to obtain the target dual-channel signal, after which the adjuster is configured to:
if the virtual sound image information comprises a height information, adjust a gain of the equalizer corresponding to the middle speaker, wherein the gain is a gain of the audio signal in a mid-high frequency range, to enhance the target virtual sound image.

In a third aspect, the present application provides a sound field equalization adjustment apparatus, comprising a processor and a memory, wherein the memory is configured to store a computer program, and the processor is configured to execute following steps:
preprocessing an acquired stereo audio signal to obtain a target dual-channel signal, wherein the target dual-channel signal comprises audio signals of different frequencies;
adjusting an equalizer of each of the dual-speakers and/or the middle speaker in a three-speaker system based on a frequency of the audio signal, such that after the target dual-channel signal is played through the dual-speakers and the middle speaker, the target virtual sound image is positioned in a direction of a real sound image, with the middle speaker located above the dual-speakers.

In a fourth aspect, the present application provides a computer-readable storage medium, wherein the computer-readable storage medium stores a plurality of instructions, the instructions are suitable for loading by a processor to execute following steps:
preprocessing an acquired stereo audio signal to obtain a target dual-channel signal, wherein the target dual-channel signal comprises audio signals of different frequencies;
adjusting an equalizer of each of the dual-speakers and/or the middle speaker in a three-speaker system based on a frequency of the audio signal, such that after the target dual-channel signal is played through the dual-speakers and the middle speaker, a target virtual sound image is positioned in a direction of a real sound image, with the middle speaker located above the dual-speakers.

Further, executing the preprocessing of the acquired stereo audio signal to obtain the target dual-channel signal comprises:
preprocessing the stereo audio signal according to a preset head-related transfer function to obtain the target dual-channel signal.

Further, the middle speaker is located on a perpendicular bisector of a line connecting the dual-speakers, and adjusting the equalizer of each of the dual-speakers and/or the middle speaker based on a frequency of the audio signal comprises:
if a frequency of the audio signal is low, increasing a gain frequency of the equalizer corresponding to the middle speaker and maintaining the equalizer of the dual-speakers at a preset equalization parameter, such that the target virtual sound image is located at a first target position, and the first target position is a position above a midpoint of a triangle formed by a connection of the dual-speakers and the middle speaker.

Further, the middle speaker is located on a perpendicular bisector of a line connecting the dual-speakers, and adjusting the equalizer of each of the dual-speakers and/or the middle speaker based on a frequency of the audio signal comprises:
if the frequency of the audio signal is a reference frequency, maintaining the equalizers of the dual-speakers and the middle speaker at preset equalization parameters, such that the target virtual sound image is located at a midpoint of a triangle formed by a connection of the dual-speakers and the middle speaker.

Further, adjusting the equalizer of each of the dual-speakers and/or the middle speaker based on the frequency of the audio signal comprises:
if the frequency of the audio signal is midrange, adjusting the equalizer of the middle speaker to a low-pass filter, while maintaining the equalizer of the dual-speakers at a preset equalization parameter, such that the target virtual sound image is located at a midpoint of a line connecting the dual-speakers.

### Beneficial Effects

The advantages of the present application are as follows. In the three-speaker system, the middle speaker is positioned above the dual-speakers. By preprocessing the stereo audio signal, a target dual-channel signal comprising audio signals of different frequencies is obtained. Then, based on the frequency of the audio signal, the equalizer for each of the dual-speakers and/or the middle speaker is adjusted accordingly. This ensures that after the target dual-channel signal is played through the dual-speakers and the middle speaker, the target virtual sound image aligns with the real sound image position in the target direction. Under the premise of a stereo audio signal, the equalization adjustment of the three-speaker system achieves a superior spatial directional virtual sound image and extended sound field compared to traditional dual-speakers systems, ensuring better sound quality while providing an enhanced virtual immersive performance.

### BRIEF DESCRIPTION OF THE DRAWINGS

The following provides a detailed description of specific embodiments of this application, accompanied by illustrations to make the technical solution and other beneficial effects of this application evident.

FIG. 1 is a structural schematic of a three-speaker system provided in an embodiment of this application.

FIG. 2 is a flow diagram illustrating a sound field equalization adjustment method provided in an embodiment of this application.

FIG. 3 is a schematic diagram of a position of a target virtual sound image provided in an embodiment of this application.

FIG. 4 is a comparative spectrum diagram of virtual sound image information provided in an embodiment of this application.

FIG. 5 is another structural schematic of a three-speaker system provided in an embodiment of this application.

FIG. 6 is a structural schematic of a sound field equalization adjustment device provided in an embodiment of this application.

FIG. 7 is a structural schematic of a sound field equalization adjustment apparatus provided in an embodiment of this application.

### DETAILED DESCRIPTION OF THE PREFERRED EMBODIMENTS

The specific structures and functional details disclosed herein are merely representative and are intended to describe exemplary embodiments of this application. However, this application may be specifically implemented in numerous alternative forms and should not be construed as being limited solely to the embodiments set forth herein.

In the description of this application, it should be understood that terms such as “center,” “lateral,” “top,” “bottom,” “left,” “right,” “vertical,” “horizontal,” “upper,” “lower,” “inner,” “outer,” and the like indicate orientation or positional relationships based on the orientations or positional relationships shown in the accompanying figures. These terms are used merely for convenience in describing the application and simplifying the description, not to imply that the devices or elements referred to must have a specific orientation, be constructed in a specific orientation, or operate in a specific orientation, and therefore should not be interpreted as limiting the application. Furthermore, terms such as “first” and “second” are used for descriptive purposes only and should not be construed as indicating or implying relative importance or as specifying the number of the referenced technical features. Thus, features defined with terms like “first” or “second” may implicitly or explicitly include one or more of the features.

In this application, unless otherwise specified, the term “plurality” refers to two or more. Additionally, the term “including,” along with any of its variations, is intended to encompass a non-exclusive inclusion. In the description of this application, it is noted that unless explicitly specified otherwise, the terms “mount,” “connect,” and “link” should be understood broadly. For instance, they may refer to a supportive connection, a detachable connection, or an integral connection; they may indicate a mechanical connection or an electrical connection; they may represent a direct connection or an indirect connection through an intermediary; or they may denote internal communication between two elements. Those skilled in the art can understand the specific meanings of these terms in this application based on the context.

The terminology used herein is for the purpose of describing particular embodiments and is not intended to limit the exemplary embodiments. Unless the context clearly indicates otherwise, the singular forms “a,” “an,” and “the” are intended to include the plural forms as well. It should also be understood that the terms “including” and/or “comprising” as used herein specify the presence of stated features, integers, steps, operations, units, and/or components, but do not preclude the presence or addition of one or more other features, integers, steps, operations, units, components, and/or combinations thereof.

The application is further described below in conjunction with the accompanying figures and embodiments.

Before introducing the sound field equalization adjustment method and apparatus, device and computer-readable storage medium of this application, a brief introduction to virtual surround sound and traditional dual-speakers systems is provided.

A virtual surround sound system is based on stereo sound, where additional channels and speakers are not added. Instead, sound field signals are processed through circuitry to create the perception of sound coming from multiple directions, resulting in a simulated surround sound experience.

When sound waves from a source reach both ears, they undergo scattering and reflection by physiological structures such as the head, pinnae, and torso. When the head and torso are stationary, sound transmission from the source to both ears can be viewed as a linear time-invariant acoustic filtering system, characterized entirely by the system's frequency-domain transfer function, known as the Head-Related Transfer Function (HRTF).

It is understood that the human auditory system generates different spectral responses for sounds coming from different directions, and the Head-Related Transfer Function can be used to describe this spectral characteristic.

In a traditional dual-speakers-to-ear system, virtual sound imaging effects can be achieved by obtaining the speaker transfer function and the Head-Related Transfer Function (HRTF), and then applying equalization filters.

However, due to the lack of sound wave radiation from above, achieving virtual positioning in spatial directions such as the vertical plane becomes highly subjective and unreliable. Without audio-visual synchronization or movement of the virtual sound source, listeners find it difficult to discern the sound's location.

To address this issue, traditional methods add two overhead channels, higher-positioned speakers, to the system. For televisions, however, adding speakers in the upper left and upper right corners would effectively increase the overall thickness and cost of the product, making this approach unsuitable.

In response to this, this application provides a sound field equalization adjustment method and apparatus, device and computer-readable storage medium. Detailed explanations are provided below.

The sound field equalization adjustment method, device, and computer-readable storage medium provided in this application can be applied to sound field equalization adjustment equipment to enhance the virtual sound imaging effect for terminal devices such as televisions, providing users with a better immersive experience.

The sound field equalization adjustment method mentioned in this application can be executed by a sound field equalization adjustment device or a television device integrated with such an adjustment device. The sound field equalization adjustment device may be implemented in hardware or software.

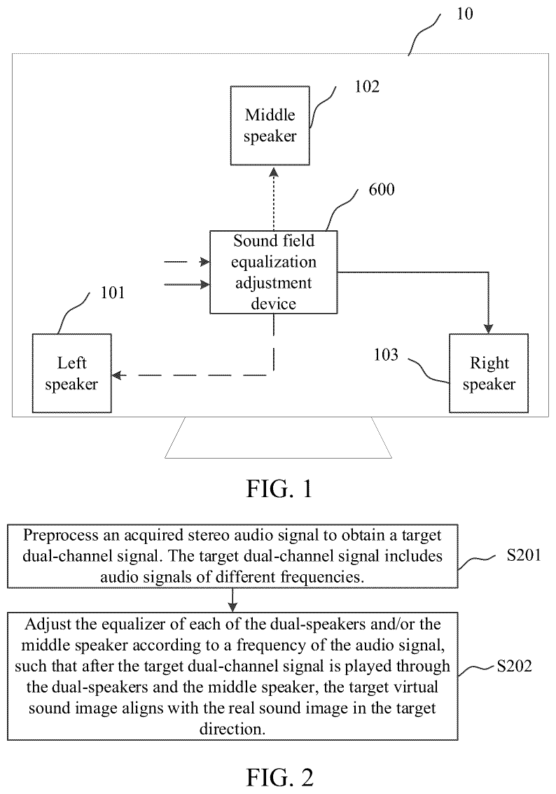

Refer to FIG. 1, FIG. 1 shows a structural schematic of a three-speaker system provided in an embodiment of this application. This three-speaker system is applied to a television 10, and the three-speaker system may include a dual-speakers located below the television 10 and a middle speaker 102 positioned above the dual-speakers. The dual-speakers can be a left speaker 101 located at the lower left of the television 10 and a right speaker 103 located at the lower right. The three-speaker system may also include a sound field equalization adjustment device 600, which can be communicatively connected to the three speakers in the system, namely the left speaker 101, middle speaker 102, and right speaker 103.

After the stereo audio signal is input to the television 10 through a signal line, the sound field equalization adjustment device 600 can receive the stereo audio signal via an internal communication line and preprocess the stereo audio signal to obtain a target dual-channel signal, which may include audio signals of different frequencies. Then, based on the frequency of the audio signals, the equalizer of each of the dual-speakers and/or the middle speaker 102 is adjusted accordingly so that after the target dual-channel signal is played through the dual-speakers and the middle speaker, the target virtual sound image aligns with the real sound image position in the target direction.

In this embodiment, given the stereo audio signal input, equalization adjustment of the three-speaker system allows for better spatial virtual sound imaging and sound field extension than existing dual-speakers systems, ensuring enhanced sound quality and a better immersive virtual performance.

First, this application provides a sound field equalization adjustment method applied to a three-speaker system. The three-speaker system includes dual-speakers and a middle speaker positioned above the dual-speakers. The sound field equalization adjustment method includes preprocessing an acquired stereo audio signal to obtain a target dual-channel signal containing audio signals of different frequencies. Based on a frequency of the audio signals, the equalizer of each of the dual-speakers and/or the middle speaker is adjusted accordingly so that, when played through the dual-speakers and the middle speaker, a target virtual sound image aligns with a real sound image position in a target direction.

Refer to FIG. 2, FIG. 2 is a flow diagram of a sound field equalization adjustment method provided in an embodiment of this application. It should be noted that while the flow diagram shows a logical sequence, the steps shown or described can be executed in an order different from that shown, depending on the situation. The sound field equalization adjustment method provided in this application specifically includes the following steps:
Step S201: Preprocess an acquired stereo audio signal to obtain a target dual-channel signal. The target dual-channel signal includes audio signals of different frequencies.

It is understood that stereo sound includes two sound channels, allowing listeners to determine the specific location of the sound source by perceiving the phase difference between the sounds reaching the left and right ears. Typically, the electrical signals transmitted by each channel in stereo sound differ, such as phase differences between the channel signals.

In this embodiment, when a user watches television programs or listens to music on the television, the stereo audio signal is continuously input into the TV through a data line. Upon receiving this signal, the three-speaker system can preprocess the stereo audio signal to generate a target dual-channel signal.

It is understood that the target dual-channel signal also includes two audio channels. Given the varying frequencies of sounds produced by different sound sources. For example, the frequency range of a bass voice is 82-392 Hz, a tenor voice is 164-698 Hz, an alto voice is 123-493 Hz, a violin is 174-3.1 kHz, and an erhu is 293-1318 Hz. The target dual-channel signal can include audio signals of different frequencies. Thus, each audio channel may contain signals of various frequencies.

In this embodiment, preprocessing of the stereo audio signal can involve appropriate filtering. The purpose of this filtering may be to eliminate noise within the stereo audio signal or to remove certain frequency bands that might cause localization errors.

In one specific implementation, the stereo audio signal can be preprocessed according to a preset Head-Related Transfer Function to obtain the target dual-channel signal.

Since the Head-Related Transfer Function describes the transmission process of sound waves from the sound source to both ears and their interactions with the head, pinnae, and torso, it can encapsulate most information needed for sound source localization. The head's scattering effect on sound waves generates conventional sound localization factors, namely interaural time difference and interaural level difference, with the significance of each factor varying across different frequency bands.

For example, at low and mid frequencies (f<1.6 kHz), interaural time difference is the primary factor for localization; at mid frequencies (1.5 kHz<f<4.0 kHz), both interaural time difference and interaural level difference play roles; and at high frequencies (f>4 kHz), interaural level difference is the primary factor.

It is understood that the Head-Related Transfer Function is a function relating to sound location. Sounds from different locations have distinct frequency response characteristics when processed through the Head-Related Transfer Function. Based on these unique frequency response characteristics, sounds from different locations can be distinguished. Thus, by preprocessing the input stereo audio signal with the Head-Related Transfer Function, the resulting target dual-channel signal can reflect the position and characteristics of the sound.
Step S202: Adjust the equalizer of each of the dual-speakers and/or the middle speaker according to a frequency of the audio signal, such that after the target dual-channel signal is played through the dual-speakers and the middle speaker, the target virtual sound image aligns with the real sound image in the target direction.

After obtaining the target dual-channel signal in Step S201, the equalizers of the dual-speakers and/or the middle speaker can be adjusted according to the different frequency components of the audio signal in the dual-channel signal. Then, the target dual-channel signal is played through the equalized dual-speakers and middle speaker, making the target virtual sound image align with the real sound image in the target direction.

It is understood that an equalizer is an electronic device that adjusts the gain of various frequency components in an electrical signal. By adjusting signals of different frequencies, the equalizer can compensate for speaker and sound field deficiencies, thereby enhancing and shaping various sound sources.

Since any gain or attenuation of frequencies involves re-quantizing the audio signal, the target dual-channel signal will also be re-quantized after it is input to the dual-speakers and middle speaker following the equalization adjustments. This re-quantization ensures that the target virtual sound image aligns with the real sound image in the target direction after playback.

It is understood that the target direction in this embodiment can be any spatial direction chosen based on the actual application scenario. For example, in some cases, the target direction can be vertical; in others, it may be an inclined direction deviating from vertical or even a horizontal direction. Thus, the selection of the target direction can vary according to practical needs, with no specific limitations provided here.

For example, since a television screen is typically perpendicular to the horizontal plane, the target direction can be set as vertical in a specific implementation. However, due to potential measurement deviations or installation errors, the television screen may not be perfectly vertical. Therefore, in this embodiment, the target direction may also encompass an approximately vertical direction, meaning it includes a range of spatial directions. This range allows for a slight angle deviation from the vertical, covering directions close to vertical within a preset tolerance, ensuring that the target virtual sound image can align with the real sound image within this directional range.

It is understood that the preset range can be an angle tolerance based on past experience or multiple experiments. If the angle deviation between the inclined direction and the vertical direction is within this range, the inclined direction can be considered equivalent to vertical. In other words, the inclined direction may also be regarded as the target direction.

In this embodiment, adjusting the equalizers of the dual-speakers and/or the middle speaker can specifically involve modifying the gain or attenuation for different frequency bands. The equalizers of the dual-speakers and/or the middle speaker can be digital or analog, depending on the actual application scenario, with no specific limitation here.

In this embodiment, the middle speaker of the three-speaker system is positioned above the dual-speakers. After preprocessing the stereo audio signal to obtain the target dual-channel signal, which includes audio signals of different frequencies, the equalizers of the dual-speakers and/or the middle speaker are adjusted according to the audio signal frequencies. This allows the target virtual sound image, when played through the dual-speakers and middle speaker, to align with the real sound image in the target direction. Under the premise of a stereo audio signal, the three-speaker system's equalization adjustment achieves superior spatial virtual sound imaging and sound field extension compared to traditional dual-speaker systems, enhancing sound quality and ensuring an immersive experience.

Next, the steps shown in FIG. 2 and specific implementation methods in practical applications will be detailed.

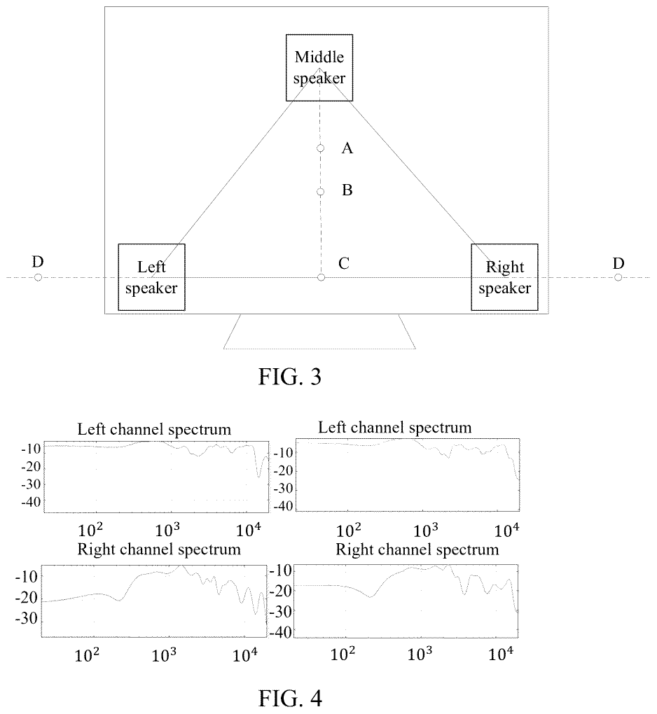

Refer to FIG. 3, FIG. 3 illustrates the position of the target virtual sound image in this embodiment. In some embodiments, the middle speaker is positioned on the vertical bisector of the line connecting the dual-speakers. Based on the frequency of the audio signal, the equalizers of the dual-speakers and/or the middle speaker are adjusted as follows:

If the frequency of the audio signal is low, increase the gain frequency of the middle speaker's equalizer while maintaining the equalizers of the dual-speakers at preset parameters.

This allows the target virtual sound image to be positioned at the first target location, which is above the midpoint of the triangle formed by the dual-speakers and the middle speaker.

An equalizer in communication systems can correct the amplitude-frequency characteristics and phase-frequency characteristics of the transmission channel. It is understood that when a sine wave of frequency f is sent into the transmission channel, the characteristic where the amplitude ratio of the output voltage to the input voltage varies with frequency f is called the amplitude-frequency characteristic, abbreviated as amplitude-frequency characteristic. The characteristic where the phase difference between the output voltage and the input voltage varies with frequency f is called the phase-frequency characteristic, abbreviated as phase-frequency characteristic.

In this embodiment of the application, since the middle speaker is located on the perpendicular bisector of the line connecting the dual-speakers and is positioned higher than the dual-speakers, the lines connecting each pair of the dual-speakers and the middle speaker can form an isosceles triangle.

If the input target dual-channel signal contains low-frequency audio signals, the parameters of the equalizers corresponding to the dual-speakers can remain unchanged, maintaining their preset equalization parameters. That is, the equalizers of the dual-speakers are not adjusted. For the middle speaker, because it is positioned above the dual-speakers, the amplitude-frequency characteristic of its corresponding equalizer can be increased. This means increasing the characteristic where the amplitude ratio of its output signal to input signal varies with frequency, allowing the position of the target virtual sound image to fall above the midpoint of the triangle formed by the three speakers. Here, above the midpoint of the triangle formed by the three speakers can be understood as being on a vertical line passing through the triangle's midpoint and closer to the middle speaker compared to the midpoint itself. As shown in FIG. 3, point B is the midpoint of the triangle formed by the three speakers, and point A can be the position of the target virtual sound image.

Compared to traditional dual-speaker systems, in this embodiment, for low-frequency audio signals, the target virtual sound image can be positioned at the higher point A, achieving a higher sound field at the physical level. This allows for the extension of the sound field of low-frequency audio signals without loss.

It is worth noting that the range or increment value by which the amplitude-frequency characteristic of the equalizer corresponding to the middle speaker is increased can be set according to actual conditions. Specifically, it can be determined based on empirical values or multiple experimental data; no specific limitations are imposed here.

Furthermore, if the input target dual-channel signal contains audio signals at the reference frequency, the parameters of the equalizers corresponding to the dual-speakers and the middle speaker can remain unadjusted, keeping all three equalizers at their preset equalization parameters. That is, the equalizers of all three speakers are not adjusted. This allows the position of the target virtual sound image to fall at the midpoint of the triangle formed by the three speakers, which is point B as shown in FIG. 3.

It is understood that the reference frequency can be a frequency within a designated reference band. In this embodiment, the reference band is set to the fundamental frequency range of human voice. In other applications, the reference band could be adjusted to other frequency ranges based on specific needs.

In one implementation, the midpoint of the triangle formed by the three speakers could coincide with the midpoint of the television screen. This setup allows the position of the target virtual sound image corresponding to the human voice's fundamental frequency (point B) to be separate from the position corresponding to low frequencies (point A), achieving improved audio performance.

If the input target dual-channel signal contains mid-frequency audio signals, the equalizer of the middle speaker can be set to a low-pass filter. In this case, only low-frequency audio signals are passed through the middle speaker, while audio signals in other bands are filtered out by the equalizer. At the same time, the equalizers of the dual-speakers can remain at preset parameters, with no adjustments made to them. Mid-frequency audio signals are fed through the dual-speakers, positioning the target virtual sound image at the midpoint of the line connecting the dual-speakers, shown as point C in FIG. 3.

Furthermore, if the target dual-channel signal contains high-frequency audio signals, sound field extension can be performed solely through the dual-speakers. Specifically, a preset Head-Related Transfer Function can be used in combination with the equalizers of the dual-speakers to achieve horizontal extension of the target virtual sound image, positioning it on the extended ends of the line connecting the dual-speakers, as shown by points D in FIG. 3.

In this embodiment, the middle speaker is located on the vertical bisector of the line connecting the dual-speakers and is positioned above them. By adjusting the equalizers of all three speakers, the target virtual sound image can be aligned with the real sound image position in the vertical direction. Meanwhile, using an optimized Head-Related Transfer Function for the horizontal direction enables sound field extension in both vertical and horizontal directions.

It is understood that the frequency divisions for low frequency, human voice fundamental frequency, mid frequency, and high frequency in the audio signal can be determined based on the specific application scenario. For example, in this embodiment, the low-frequency range may be 30-400 Hz, the human voice fundamental frequency range 400-500 Hz, the mid-frequency range 500-5 kHz, and the high-frequency range 5 kHz- 16 kHz.

In this embodiment, the three-speaker system does not require a three-channel source signal as input. Instead, a 2.0 stereo channel (dual channel) can be used. By preprocessing the stereo audio signal and adjusting the equalizers accordingly, the signal can be fed to the middle and dual-speakers, enabling audio playback suitable for any 2.0 channel source material to achieve sound field extension.

In some embodiments of this application, the target dual-channel signal may also carry virtual sound image information. By preprocessing the acquired stereo audio signal, a target dual-channel signal is obtained. The sound field equalization adjustment method may then further include the following:

If the virtual sound image information includes height information, the gain of the middle speaker's equalizer is adjusted, specifically the gain of the mid-high frequency range, to enhance the target virtual sound image.

Specifically, after preprocessing the stereo audio signal with the Head-Related Transfer Function, the resulting target dual-channel signal can carry virtual sound image information, such as height information. In this case, the frequency spectrum of the target dual-channel signal may include height information.

Refer to FIG. 4, FIG. 4 shows a spectrum comparison diagram of the virtual sound image information. The left side depicts the left and right channel spectrums without height information, while the right side includes height information.

Differences in the gain of the high-frequency spectrum indicate the presence or absence of height information in the virtual sound image. Thus, by examining the gain in the high-frequency portion of the target dual-channel signal's spectrum, it can be determined whether the virtual sound image information includes height information.

If height information is present, the higher physical position of the middle speaker can be utilized to adjust its equalizer's gain in the mid-high frequency range. This enhancement of height information through processing the mid-high frequencies results in a better virtual sound image.

In this case, adjusting the middle speaker's equalizer gain may involve increasing or attenuating the gain in the mid-high frequency range. The specific adjustment magnitude can be determined based on the actual application scenario and is not limited here.

If the virtual sound image information does not include height information, the virtual spatial positioning in the horizontal direction can be generated by the dual-speakers using traditional methods, meaning no adjustment to the middle speaker is necessary.

In this embodiment, under the premise of using traditional methods for virtual sound imaging or surround sound playback through the dual-speakers, the middle speaker, located at a higher position, can output the mid-high frequency audio signal with adjusted gain. This approach enhances the virtual positioning, creating a higher, more accurately positioned virtual sound image.

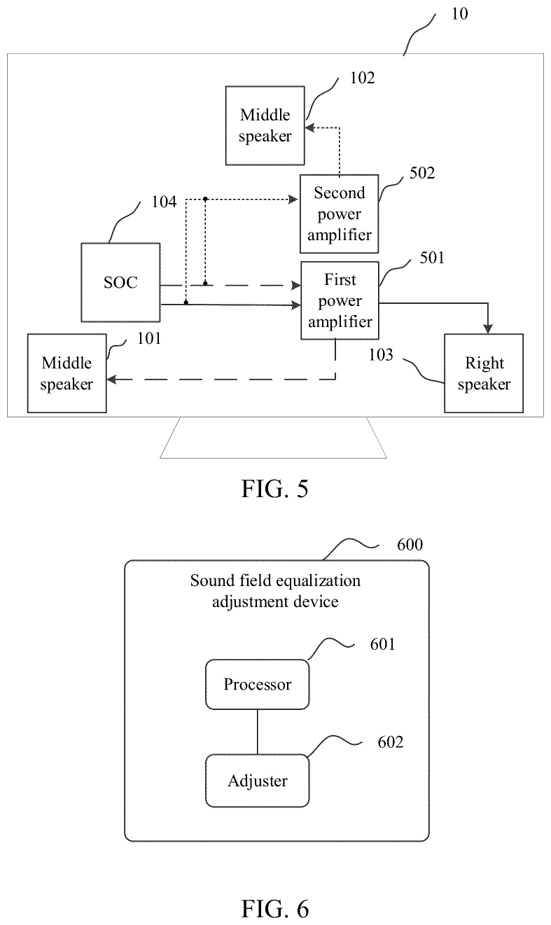

Refer to FIG. 5, FIG. 5 shows another structural diagram of the three-speaker system in this embodiment. In one specific implementation, the three-speaker system in this embodiment can be realized with dual amplification. The first power amplifier 501 controls the dual-speakers located below, and the second power amplifier 502 controls the middle speaker 102. After the stereo audio signal is input to the TV 10 through a signal line, the processor in the sound field equalization adjustment device 600 such as SystemOn Chip (SOC) 104 receives the stereo audio signal through an internal communication line and preprocesses it to obtain the target dual-channel signal, which may include audio signals of different frequencies. The target dual-channel signal is then processed by the first power amplifier 501, which feeds the left speaker 101 and right speaker 103, and by the second power amplifier 502, which feeds the middle speaker 102. This configuration achieves improved vertical virtual sound imaging and sound field extension compared to dual-speakers alone, ensuring a more immersive experience for the user.

The above describes the sound field equalization adjustment method in this application's embodiment. To facilitate the implementation of the provided sound field equalization adjustment method, this application also provides a sound field equalization adjustment device.

Refer to FIG. 6, FIG. 6 shows a structural diagram of the sound field equalization adjustment device in this embodiment. In this application, the sound field equalization adjustment device 600 can be applied to a three-speaker system, which includes dual-speakers and a middle speaker located above the dual-speakers. The sound field equalization adjustment device 600 can specifically include the following structures:

Processor 601 configured to preprocess the acquired stereo audio signal, obtaining a target dual-channel signal. The target dual-channel signal includes audio signals of different frequencies.

Adjuster 602 configured to adjust the equalizers of the dual-speakers and/or the middle speaker according to the frequency of the audio signal. This adjustment ensures that the target virtual sound image, when played through the dual-speakers and middle speaker, aligns with the real sound image in the target direction.

In this embodiment, the middle speaker in the three-speaker system is positioned above the dual-speakers. The processor 601 preprocesses the stereo audio signal to generate the target dual-channel signal, which includes audio signals of different frequencies. The adjuster 602 then adjusts the equalizers of the dual-speakers and/or the middle speaker according to the audio signal frequencies, aligning the target virtual sound image with the real sound image position in the target direction. This approach enables better spatial virtual sound imaging and sound field extension than traditional dual-speaker systems, ensuring enhanced audio quality and a more immersive virtual experience.

In some embodiments, the processor 601 can configured to:

perform preprocessing on the stereo audio signal based on a preset Head-Related Transfer Function to obtain the target dual-channel signal.

In other embodiments, when the middle speaker is located on the vertical bisector of the line connecting the dual-speakers, the adjuster 602 can be used to:
increase the amplitude-frequency response of the middle speaker's equalizer if the audio signal frequency is low, while maintaining the dual-speakers'equalizers at preset parameters. This ensures that the target virtual sound image is positioned at the first target location, which is above the midpoint of the triangle formed by the dual-speakers and the middle speaker.

In some embodiments of this application, when the middle speaker is positioned on the vertical bisector of the line connecting the dual-speakers, the adjuster 602 can be specifically configured as follows:

If the frequency of the audio signal corresponds to the reference frequency, the equalizers of the dual-speakers and the middle speaker all remain at preset parameters. This positions the target virtual sound image at the midpoint of the triangle formed by the dual-speakers and the middle speaker.

In some embodiments of this application, the adjuster 602 can be specifically configured as follows:

If the audio signal frequency is in the mid-frequency range, the middle speaker's equalizer is set to a low-pass filter, while the dual-speakers'equalizers remain at preset parameters. This positions the target virtual sound image at the midpoint of the line connecting the dual-speakers.

In some embodiments of this application, the adjuster 602 can be specifically configured as follows:

If the audio signal frequency is in the high-frequency range, the target virtual sound image is horizontally extended based on the dual-speakers'equalizers and the preset Head-Related Transfer Function, placing the virtual sound image on the extended ends of the line connecting the dual-speakers.

In some embodiments, if the target dual-channel signal contains virtual sound image information, the processor 601 preprocesses the stereo audio signal to obtain the target dual-channel signal, and then the adjuster 602 is specifically configured to:

Adjust the gain of the middle speaker's equalizer if the virtual sound image information includes height information. The gain adjustment applies to the mid-high frequency range to enhance the target virtual sound image.

It should be noted that the functionalities of processor 601 and adjuster 602 described here correspond to those discussed earlier. Professionals in the field will understand that, for simplicity, the specific operations of the sound field equalization adjustment device and its modules can be referenced in the description of the sound field equalization adjustment method in FIG. 2, and further details are omitted here.

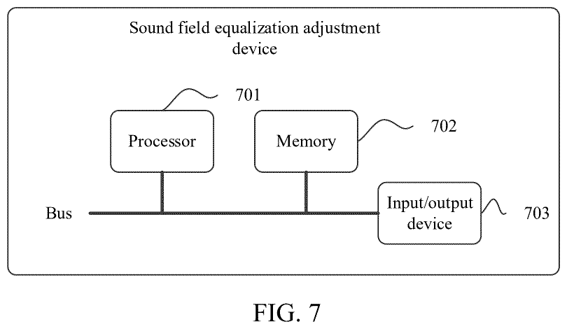

This application also provides a sound field equalization adjustment apparatus. Refer to FIG. 7, FIG. 7 shows a structural diagram of the sound field equalization adjustment apparatus in this embodiment. Specifically, this sound field equalization adjustment apparatus may include a processor 701, a memory 702, and an input/output device 703. The processor 701 is configured to execute the computer program stored in memory 702 to perform each step of the sound field equalization adjustment method described in FIG. 2 or to implement the functionalities of each unit module described in FIG. 6. The memory 702 is configured to store the computer program required for the processor 701 to execute the sound field equalization adjustment method described in FIG. 2.

Exemplarily, the computer program can be divided into one or more modules/units, with one or more modules/units stored in memory 702 and executed by processor 701 to complete this application. Each module/unit may consist of a series of computer program instructions capable of performing specific functions, describing the execution process of the computer program within the device.

The sound field equalization adjustment device may include, but is not limited to, a processor 701, a memory 702, and an input/output device 703. It will be understood by those skilled in the art that the diagram is merely an example of the sound field equalization adjustment device and does not limit its structure. The device may include more or fewer components than shown, or combine or substitute certain components. For example, the sound field equalization adjustment device may also include network access equipment, a bus, etc., with the processor 701, the memory 702, the input/output device 703, and network access equipment interconnected via the bus.

The processor 701 may be a Central Processing Unit (CPU), or it could be another general-purpose processor, Digital Signal Processor (DSP), Application Specific Integrated Circuit (ASIC), Field-Programmable Gate Array (FPGA), or other programmable logic device, discrete gate or transistor logic device, discrete hardware components, etc. A general-purpose processor could be a microprocessor or any conventional processor, and it serves as the control center of the sound field equalization adjustment device, connecting and managing all device components through various interfaces and connections.

The memory 702 can be used to store computer programs and/or modules. By running or executing the stored computer programs and/or modules, the processor 701, along with data stored in the memory 702, implements various device functions. The memory 702 may mainly include a program storage area and a data storage area. The program storage area can store the operating system and application programs necessary for at least one function, while the data storage area can store data generated during the use of the sound field equalization adjustment device. Memory may also include high-speed random access memory, as well as non-volatile memory such as a hard disk, memory, plug-in hard disk, Smart Media Card (SMC), Secure Digital (SD) card, flash card, at least one disk storage device, flash memory device, or other non-volatile solid-state storage devices.

When the processor 701 executes the computer program stored in the memory 702, it can specifically perform the following functions:

Preprocess the acquired stereo audio signal to obtain a target dual-channel signal, where the target dual-channel signal includes audio signals of different frequencies.

Adjust the equalizers of the dual-speakers and/or middle speaker according to the frequencies of the audio signals, allowing the target virtual sound image, when played through the dual-speakers and middle speaker, to align with the real sound image in the target direction.

It will be understood by those skilled in the art that, for the sake of simplicity, the specific operational processes of the sound field equalization adjustment device, apparatus, and corresponding units can be referenced from the description of the sound field equalization adjustment method in any embodiment in FIG. 2, and further details are omitted here.

It should also be understood by those skilled in the art that all or part of the steps in the various methods of the above embodiments can be completed through instructions or by controlling related hardware via instructions. These instructions can be stored in a computer-readable storage medium and loaded and executed by a processor.

Accordingly, this application provides a computer-readable storage medium that stores multiple instructions. These instructions can be loaded by a processor to execute the steps of the sound field equalization adjustment method described in any embodiment in FIG. 2. Specific operations can be referenced from the description of the sound field equalization adjustment method in any embodiment in FIG. 2, which is not further elaborated here.

This computer-readable storage medium may include Read-Only Memory (ROM), Random Access Memory (RAM), disk, optical disk, and so forth.

As the instructions stored in the computer-readable storage medium can perform the steps of the sound field equalization adjustment method described in any embodiment in FIG. 2, it can achieve the beneficial effects as described in any embodiment in FIG. 2, as detailed in the previous description, and is not repeated here.

The specific implementation of each operation mentioned above can be found in the previous embodiments and is not repeated here.

In summary, although this application has been disclosed above with preferred embodiments, these preferred embodiments are not intended to limit this application. Those skilled in the art may make various modifications and refinements without departing from the spirit and scope of this application. Therefore, the scope of this application is defined by the claims.

1. A sound field equalization adjustment method, wherein the sound field equalization adjustment method is applied to a three-speaker system, the three-speaker system comprises a dual-speakers and a middle speaker located above the dual-speakers, the sound field equalization adjustment method comprises:
preprocessing an acquired stereo audio signal to obtain a target dual-channel signal, wherein the target dual-channel signal comprises audio signals of different frequencies; and
adjusting an equalizer of each of the dual-speakers and/or the middle speaker based on the frequency of the audio signal, so that after the target dual-channel signal is played through the dual-speakers and the middle speaker, a target virtual sound image is positioned in a direction of a real sound image.

2. The sound field equalization adjustment method according to claim 1, wherein preprocessing the acquired stereo audio signal to obtain the target dual-channel signal comprises:
preprocessing the stereo audio signal according to a preset head-related transfer function to obtain the target dual-channel signal.

3. The sound field equalization adjustment method according to claim 1, wherein the middle speaker is located on a perpendicular bisector of a line connecting the dual-speakers, and adjusting the equalizer of each of the dual-speakers and/or the middle speaker based on the frequency of the audio signal comprises:
if the frequency of the audio signal is low, increasing a gain frequency of the equalizer corresponding to the middle speaker and maintaining the equalizer of the dual-speakers at a preset equalization parameter, such that the target virtual sound image is located at a first target position, and the first target position is a position above a midpoint of a triangle formed by a connection of the dual-speakers and the middle speaker.

4. The sound field equalization adjustment method according to claim 1, wherein the middle speaker is located on a perpendicular bisector of a line connecting the dual-speakers, and adjusting the equalizer of each of the dual-speakers and/or the middle speaker based on the frequency of the audio signal comprises:
if the frequency of the audio signal is a reference frequency, maintaining the equalizers of the dual-speakers and the middle speaker at preset equalization parameters, such that the target virtual sound image is located at a midpoint of a triangle formed by a connection of the dual-speakers and the middle speaker.

5. The sound field equalization adjustment method according to claim 1, wherein adjusting the equalizer of each of the dual-speakers and/or the middle speaker based on the frequency of the audio signal comprises:
if the frequency of the audio signal is midrange, adjusting the equalizer of the middle speaker to a low-pass filter, while maintaining the equalizer of the dual-speakers at a preset equalization parameter, such that that the target virtual sound image is located at a midpoint of a line connecting the dual-speakers.

6. The sound field equalization adjustment method according to claim 1, wherein adjusting the equalizer of each of the dual-speakers and/or the middle speaker based on the frequency of the audio signal comprises:
if the frequency of the audio signal is high, horizontally extending the target virtual sound image based on the equalizer corresponding to the dual-speakers and a preset head-related transfer function, such that the target virtual sound image is located on an extended line at both ends of a line connecting the dual-speakers.

7. The sound field equalization adjustment method according to claim 1, wherein the target dual-channel signal carries a virtual sound image information, and after preprocessing the acquired stereo audio signal to obtain the target dual-channel signal, the method further comprises:
if the virtual sound image information comprises a height information, adjusting a gain of the equalizer corresponding to the middle speaker, wherein the gain is a gain of the audio signal in a mid-high frequency range, to enhance the target virtual sound image.

8. A sound field equalization adjustment device, wherein the sound field equalization adjustment device is applied to a three-speaker system, the three-speaker system comprises a dual-speakers and a middle speaker located above the dual-speakers, the sound field equalization adjustment device comprises:
a processor configured to preprocess the acquired stereo audio signal to obtain a target dual-channel signal, wherein the target dual-channel signal comprises audio signals of different frequencies; and
an adjuster configured to adjust an equalizer of the dual-speakers and/or the middle speaker based on the frequency of the audio signal, such that a target virtual sound image is positioned in a direction of a real sound image.

9. The sound field equalization adjustment device according to claim 8, wherein the processor is configured to preprocess the stereo audio signal according to a preset head-related transfer function to obtain the target dual-channel signal.

10. The sound field equalization adjustment device according to claim 8, wherein the middle speaker is located on a perpendicular bisector of a line connecting the dual-speakers; wherein the adjuster is configured to:
if a frequency of the audio signal is low, increase a gain frequency of the equalizer corresponding to the middle speaker and maintain the equalizer of the dual-speakers at a preset equalization parameter, such that the target virtual sound image is located at a first target position, and the first target position is a position above a midpoint of a triangle formed by a connection of the dual-speakers and the middle speaker.

11. The sound field equalization adjustment device according to claim 8, wherein the middle speaker is located on a perpendicular bisector of a line connecting the dual-speakers, and the adjuster is configured to:
if a frequency of the audio signal is a reference frequency, maintain the equalizers of the dual-speakers and the middle speaker at preset equalization parameters, such that the target virtual sound image is located at a midpoint of a triangle formed by a connection of the dual-speakers and the middle speaker.

12. The sound field equalization adjustment device according to claim 8, wherein the adjuster is configured to:
if a frequency of the audio signal is midrange, adjust the equalizer of the middle speaker to a low-pass filter, while maintaining the equalizer of the dual-speakers at a preset equalization parameter, such that the target virtual sound image is located at a midpoint of a line connecting the dual-speakers.

13. The sound field equalization adjustment device according to claim 8, wherein the adjuster is configured to:
if a frequency of the audio signal is high, horizontally extending the target virtual sound image based on the equalizer corresponding to the dual-speakers and a preset head-related transfer function, such that the target virtual sound image is located on an extended line at both ends of a line connecting the dual-speakers.

14. The sound field equalization adjustment device according to claim 8, wherein the target dual-channel signal carries a virtual sound image information, and the processor preprocesses the acquired stereo audio signal to obtain the target dual-channel signal, after which the adjuster is configured to:
if the virtual sound image information comprises a height information, adjust a gain of the equalizer corresponding to the middle speaker, wherein the gain is a gain of the audio signal in a mid-high frequency range, to enhance the target virtual sound image.

15. A sound field equalization adjustment apparatus, comprising a processor and a memory, wherein the memory is configured to store a computer program, and the processor is configured to execute following steps:
preprocessing an acquired stereo audio signal to obtain a target dual-channel signal, wherein the target dual-channel signal comprises audio signals of different frequencies; and
adjusting an equalizer of each of the dual-speakers and/or the middle speaker in a three-speaker system based on a frequency of the audio signal, such that after the target dual-channel signal is played through the dual-speakers and the middle speaker, the target virtual sound image is positioned in a direction of a real sound image, with the middle speaker located above the dual-speakers.

16-20. (canceled)

21. The sound field equalization adjustment apparatus according to claim 15, wherein the processor is configured to preprocess the stereo audio signal according to a preset head-related transfer function to obtain the target dual-channel signal.

22. The sound field equalization adjustment apparatus according to claim 15, wherein the middle speaker is located on a perpendicular bisector of a line connecting the dual-speakers, and wherein the processor is configured to:
if a frequency of the audio signal is low, increase a gain frequency of the equalizer corresponding to the middle speaker and maintain the equalizer of the dual-speakers at a preset equalization parameter, such that the target virtual sound image is located at a first target position, and the first target position is a position above a midpoint of a triangle formed by a connection of the dual-speakers and the middle speaker.

23. The sound field equalization adjustment apparatus according to claim 15, wherein the middle speaker is located on a perpendicular bisector of a line connecting the dual-speakers, and the processor is configured to:
if a frequency of the audio signal is a reference frequency, maintain the equalizers of the dual-speakers and the middle speaker at preset equalization parameters, such that the target virtual sound image is located at a midpoint of a triangle formed by a connection of the dual-speakers and the middle speaker.

24. The sound field equalization adjustment apparatus according to claim 15, wherein the processor is configured to:
if a frequency of the audio signal is midrange, adjust the equalizer of the middle speaker to a low-pass filter, while maintaining the equalizer of the dual-speakers at a preset equalization parameter, such that the target virtual sound image is located at a midpoint of a line connecting the dual-speakers.

25. The sound field equalization adjustment apparatus according to claim 15, wherein the processor is configured to:
if a frequency of the audio signal is high, horizontally extending the target virtual sound image based on the equalizer corresponding to the dual-speakers and a preset head-related transfer function, such that the target virtual sound image is located on an extended line at both ends of a line connecting the dual-speakers.
